(19) United States
(12) Patent Application Publication
(10) Pub. No.: US 2012/0211988 A1
(43) Pub. Date: Aug. 23, 2012

(54) Submersible electric power generator system

(76) Inventor: Richard Harding, Pearl, MS (US)

(21) Appl. No.: 12/929,889

(22) Filed: Feb. 23, 2011

(51) Int. Cl. F03B 13/10

(52) U.S. Cl. 290/54

(57) ABSTRACT

A submersible electric power generation system includes one or more propeller units interconnected by universal joints, and a generator stage at one end of the propeller unit or units and interconnected thereto by a universal joint and a generator drive shaft. The generation system is deployed within a flowing stream of water so that the propeller units transmit rotational torque, caused by the flowing stream of water, to the generator stage for generating electrical power. The generation system is deployed into the water by a set of arms controlled by a control unit disposed within a water going vessel. The propeller units' buoyancy and the universal joints encourage an undulating movement within a flowing stream which serves to protect the system from damage caused by debris carried within the flowing stream.

### FIELD OF THE INVENTION

The invention is directed to a submersible electric power generator system wherein the turbine or propeller assembly is disposed underwater and is driven by a flowing stream such as, for example, a river.

### BACKGROUND

A generator system for converting a fluid stream into electrical energy without the burning of fossil fuel has long been desirable. Large scale hydroelectric power plants are well known in the art and typically require a huge volume of water that descends from a relatively high elevation to a lower elevation so as to drive turbine blades that are connected to a generator. Hydroelectric power plants typically utilize naturally occurring water falls, e.g., Niagara Falls on the US Canadian border, and man made dams such as Hoover Dam in Nevada. However, such large scale hydroelectric power plants are costly to build and once built cannot be disassembled and moved to another location.

### SUMMARY

The submersible electric power generator system provides at least one submersible turbine blade or propeller unit which is disposed in a flowing body of water with the generator portion of the system also deposed underwater. In a preferred embodiment, the submersible electric power generation system includes a plurality of turbine blade or propeller units which are disposed in a flowing body of water with the generator portion of the system also deposed underwater. The body of water can be silt laden and debris filled such as, for example, the Mississippi river.

Each propeller unit constitutes a series of individual propellers constructed with a large hollow barrel like hub of sufficient size to render each propeller unit slightly buoyant. The propeller blades can be constructed of virtually any material and can even be hollow to further assist in the buoyancy of the assembly.

The propeller unit is interconnected via a universal joint to provide rotational force to the drive shaft of a generator. In the preferred embodiment, independent propeller units are interconnected via universal joints between them, and are also configured to provide rotational force to the generator disposed at one end of the interconnected propeller units. The rotational force developed by the propeller unit or units is translated through the universal joints to the generator drive shaft causing an armature of electrical wiring disposed within an electric field to thereby generate electrical power, as is well known in the art.

The universal joint encourages undulating movement of the propeller unit in relation to the generator when disposed in the flowing stream. In the preferred embodiment, the propeller units are configured to decrease in radial size so as to encourage the snake like undulation when disposed in the flowing stream. The undulation helps to free any debris carried by the flowing stream that might get entangled in one or more of the propeller units.

The submersible electric power generator system is mounted at the generator end to a set of arms which allows deployment of the system in the flowing stream at selectable depths from a water going vessel such as a barge, boat or the like. The arms can be spring loaded or include hydraulic cylinders to provide relative vertical movement if the submersible electric power generator system is struck by debris carried within the flowing stream of water. The arms can be operated to deploy the generator system by a mechanical crank and gearing arrangement, as is well known in the art, or by a conventional electric motor and gearing system.

Insulated waterproof wiring from the generator can be brought aboard the water going vessel and connected to an alternator, ac/dc converter, battery or other electrical storage device. Alternatively, the waterproof wiring from the generator can be brought onto land for powering electrical equipment or connection to electrical storage devices.

The submersible electric power generator system can be anchored within a flowing stream or body of water having tidal currents. In the case of water having tidal currents the submersible electric power generator system can be disposed so as to be rotatable on an anchored pole or pier so that it can rotate in accordance with the tidal flow to maximize electrical power generation.

In another exemplary embodiment, the submersible electric power generator system can be made buoyant by the provision of inflatable bladders or tubes between propeller units, and between the propeller unit and generator. An air compressor can provide compressed air through air passages or tubing that interconnects the bladders or tubes between the propeller sections.

### BRIEF DESCRIPTION OF THE DRAWINGS

FIG. 1 shows a perspective view of a non-limiting exemplary embodiment of the submersible electric power generator system;

FIG. 2 shows a plan view of the system shown in FIG. 1;

FIG. 3 shows a profile view of the system shown in FIG. 1;

FIG. 4 shows an end view of the system shown in FIG. 1;

FIG. 5 shows another view of the system shown in FIG. 1;

FIG. 6 shows the system shown in FIG. 1 disposed underwater;

FIG. 7 shows a top view of the system shown in FIG. 1 disposed underwater using a weight and anchor arrangement;

FIG. 8 shows a side view of the system shown in FIG. 1 disposed underwater using a weight and anchor arrangement;

FIG. 9 shows the system shown in FIG. 1 disposed rotatable on an anchored pole or pier for positioning in accordance with the tidal flow of the water which allows rotation underwater using a weight and anchor arrangement;

FIG. 10 shows another embodiment of the system shown in FIG. 1;

FIG. 11 shows one propeller unit of the FIG. 10 system; and

FIG. 12 shows in cross section the propeller unit shown in FIG. 11.

### DETAILED DESCRIPTION

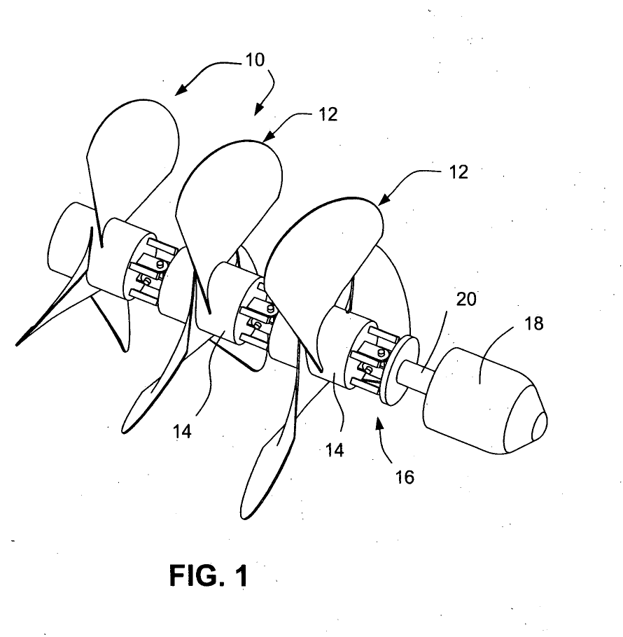

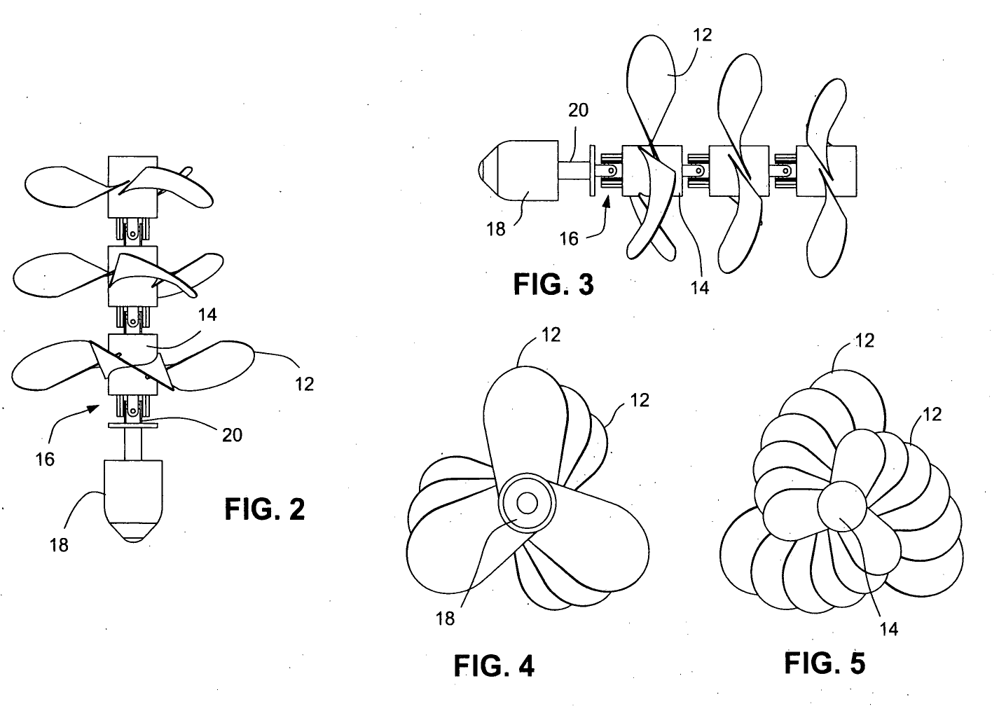

FIGS. 1-3 respectively show perspective, plan and profile views of a non-limiting exemplary embodiments of the submersible electric power generator system to include one or a series of propeller units 10 each having a propeller 12 disposed on a hub 14. Although for convenience the system is shown with three propeller units, the system can include only a single propeller unit or a plurality of propeller units, but is not limited to the three shown. The propeller units 10 are interconnected to each other by universal joints 16 with the first propeller unit being interconnected to generator system 18 through universal joint 16 and drive shaft 20.

Propeller units 10 are designed to impart rotational motion to generator system 18 when the propeller units are disposed within a flowing stream. As is well known in the art, generator system 18 includes a wound wire coil (not shown) disposed within a magnetic field (not shown) so as to generate electrical current when the wound core is caused to rotate within the magnetic field by the propeller units.

Propellers 12 and hubs 18 are preferably slightly buoyant to encourage an undulating or snakelike motion when disposed under water and to remove weight from the generator shaft. The diameter size of each propeller unit 10 decreases as its distance from the generator system increases which thereby further encourage the undulating or snakelike motion of the propeller units when submerged underwater. FIGS. 4 and 5 respectively show end views of propeller units 10.

Although the preferred embodiment involves generator system 18 being submerged underwater together with propeller units 10, those skilled in the art will recognize that generator system 18 could be disposed above water with suitable coupling connections to propeller units 10 which are submerged.

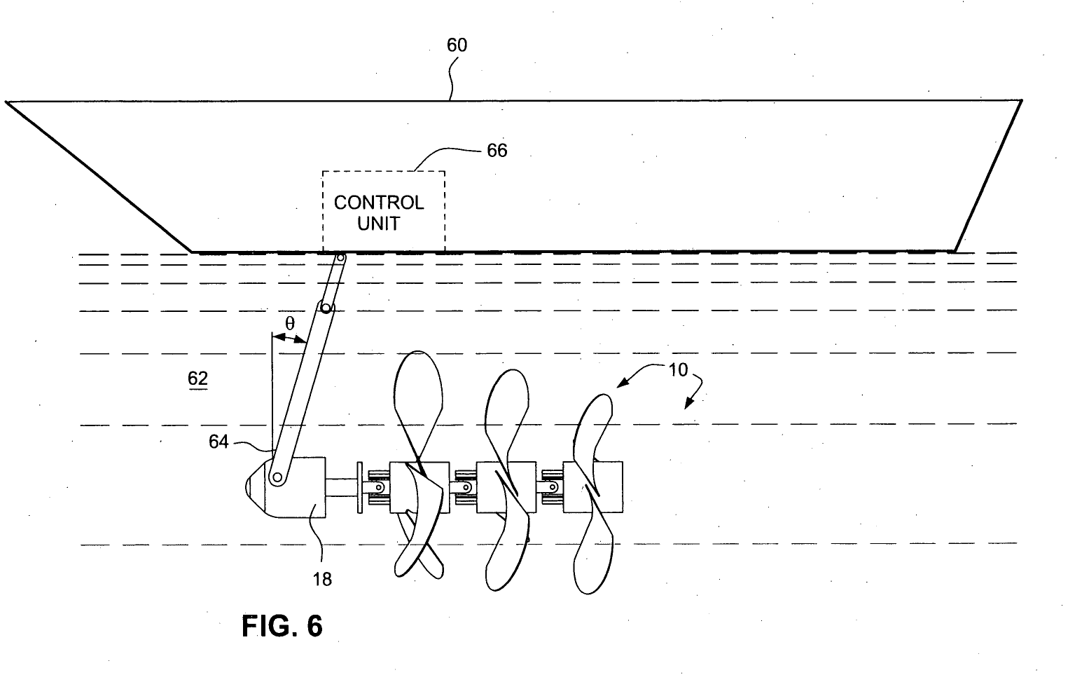

FIG. 6 shows propeller units 10 and generator system 18 disposed underwater (shown as 62) from a boat or other water going vessel 60 via arms 64. The level at which the submersible electric power generation system is disposed underwater is determined by the angle θ formed between a perpendicular line to the generation system and arms 64. The maximum depth at which the generation system can be disposed is when angle θ equals zero degrees, and the minimum depth is realized as angle θ approaches ninety degrees.

Arms 64 can be arranged to lock in at one or more specific angles θ or can be arranged to be locked in at virtually any angle θ between zero degrees and nearly 90 degrees. Preferably, arms 64 include damping springs, hydraulic cylinders or the like within their casing so that the arms can slightly retract upwards, and away from, debris carried within the flowing stream that strikes the generation system.

Control unit 66, disposed within water going vessel 60, is operated to deploy arms 64 at a particular depth. Control unit 66 can be a hand operated crank and gear arrangement (not shown) or a conventional electric motor and gear arrangement (not shown). Suitably insulated electrical wires (not shown) are connected from generator system 18 to electrical powered equipment (not shown) or to an electrical storage device (not shown) aboard water going vessel 60. Alternatively, the insulated electrical wires could be connected to these electrical devices on dry land.

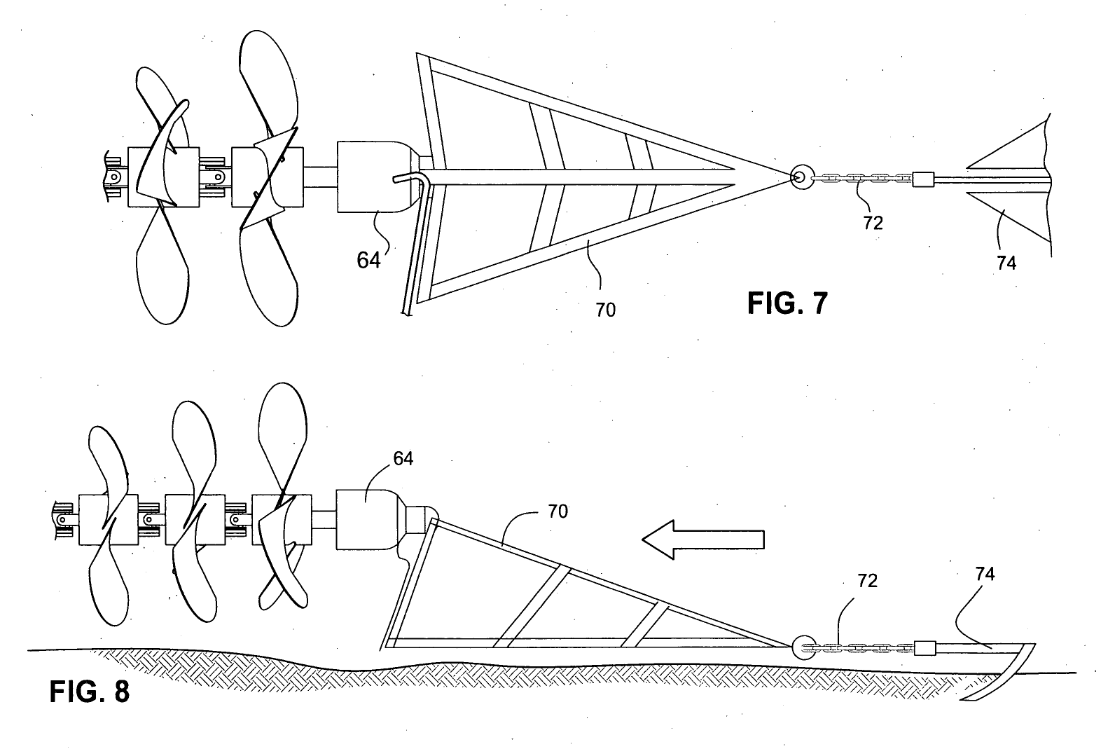

FIG. 7 shows a top view of an exemplary embodiment in which the submersible electric power generator system is disposed underwater using iron frame 70 which is connected via chain 72 to anchor 74. FIG. 8 shows a side view of this deployment with anchor 74 embedded in the river bottom. As in the embodiment described above with respect to FIG. 6, insulated electrical wires from generator system 18 are connected to electrical powered equipment (not shown) or to electrical storage devices (not shown) either aboard a water going vessel or on dry land.

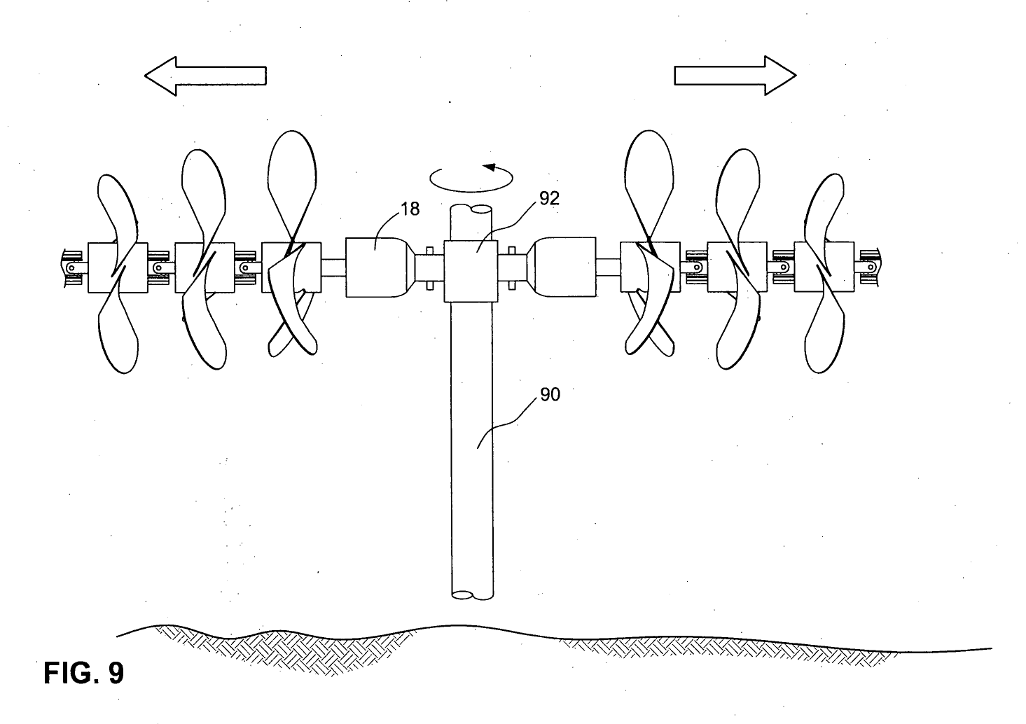

FIG. 9 shows another exemplary embodiment in which the submersible electric power generator system is disposed on a rotatable collar 92 which is coupled to embedded pole or pier 90 in a body of water. Depending on the current or tidal flow of the body of the water the submersible electric power generator system will rotate around pole or pier 90 to align itself with the prevailing current or tide of the body of water. This embodiment has the advantage that it can generate electrical power on incoming or outgoing tides as well as in rivers or streams in which the current changes direction. As in the embodiments described previously, insulated electrical wires from generator system 18 are connected to electrical powered equipment (not shown) or to electrical storage devices (not shown) either aboard a water going vessel or on dry land.

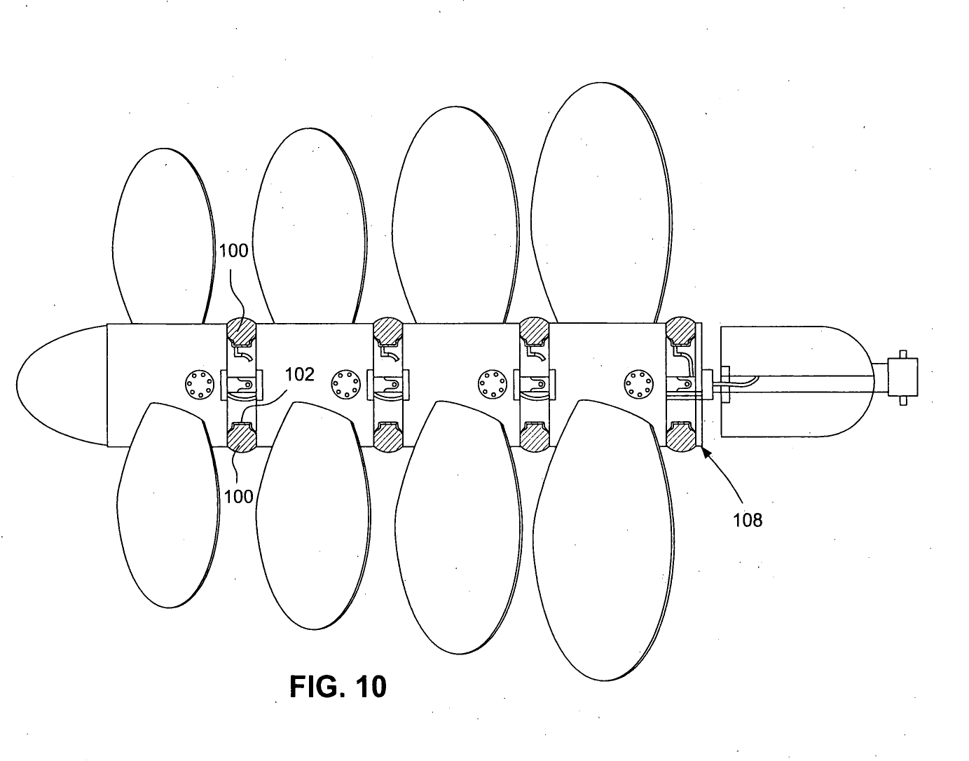

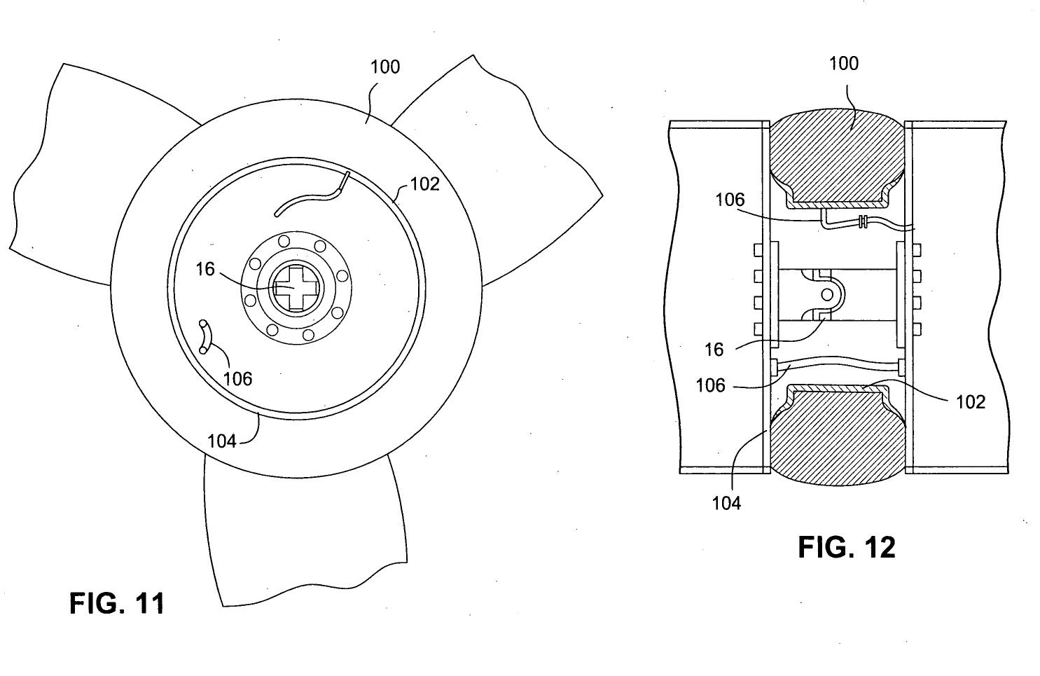

FIGS. 10-12 depict yet another embodiment that uses bladders or tubes 100 disposed between propeller units 10 and between the propeller and the generator. The bladders or tubes 100 are filled with compressed air to provide buoyancy to the submersible electric power generator system. The amount of compressed air provided to bladders or tubes 100 can be used to determine the rigidity or flexibility of the propeller units in relation to each other. The bladders or tubes 100 can be formed onto outer rim 102 of a hollow drum 104. Drum 104 also has universal joints 16 bolted to its faces. Air hoses 106 connect an air compressor (not shown) to each one of bladders or tubes 100. A plate hub 108 is disposed on generator system 18 to accommodate universal joint 16 and bladder or tube 100.

While the technology herein has been described in connection with exemplary illustrative non-limiting implementations, the invention is not to be limited by the disclosure. For example, instead of providing air filled bladders between propeller units for providing flexibility conventional springs could be deployed. The invention is intended to be defined by the claims and to cover all corresponding and equivalent arrangements whether or not specifically disclosed herein.

What is claimed:

1. A submersible electric power generation system comprising:
a plurality of propeller units each having propeller blades carried on a hub;
a plurality of universal joints for interconnecting the plurality of propeller units so as to impart rotational motion, generated by a flowing stream of water impinging on said propeller units, to a drive shaft; and
a generator stage interconnected to said plurality of propeller units through a universal joint and said drive shaft;
wherein the diameter of each one of said plurality of propeller units decreases in size the farther away said each one of said plurality of propeller units is disposed from said generator stage.

2. The submersible power generation system of claim 1, further comprising a set of movable arms attached to said generator stage for deploying the submersible power generation system at various depths in a flowing stream of water.

3. The submersible power generation system of claim 2, wherein said set of movable arms comprise damping springs for providing relative vertical movement when the submersible power generation system is struck by debris carried within the flowing stream of water.

4. The submersible power generation system of claim 2, wherein said set of movable arms comprise hydraulic pistons for providing relative vertical movement when the submersible power generation system is struck by debris carried within the flowing stream of water.

5. The submersible power generation system of claim 1, wherein said propeller blades are buoyant.

6. The submersible power generation system of claim 5, wherein said hubs are buoyant.

7. The submersible power generation system of claim 6, wherein said propeller blades and hubs are hollow.

8. The submersible power generation system of claim 2, further comprising a control unit for controlling said arms to deploy said generator system.

9. The submersible power generation system of claim 1, further comprising an anchor assembly for anchoring said system within a body of water.

10. The submersible power generation system of claim 1, further comprising a rotatable collar for deploying said system rotatably to a pole embedded in a body of water.

11. The submersible power generation system of claim 1, wherein each one of said plurality of propeller units further comprising a floatable device for providing buoyancy.

12. The submersible power generation system of claim 20, wherein said floatable device comprises an inflatable bladder or tube.

13. A submersible electric power generation system comprising:
a propeller unit having propeller blades carried on a hub;
a generator stage having a drive shaft;
a universal joint for interconnecting the propeller unit to the drive shaft so as to impart rotational motion generated by a flowing stream of water impinging on said propeller unit to the drive shaft;
said drive shaft of said generator stage being connected to said propeller unit through a universal joint; and
an inflatable bladder or tube disposed around said propeller unit to provide buoyancy.

14. The submersible power generation system of claim 13, further comprising a set of movable arms attached to said generator stage for deploying the submersible power generation system at various depths in a flowing stream of water.

15. The submersible power generation system of claim 14, wherein said set of movable arms comprise damping springs for providing relative vertical movement when the submersible power generation system is struck by debris carried within the flowing stream of water.

16. The submersible power generation system of claim 14, wherein said set of movable arms comprise hydraulic pistons for providing relative vertical movement when the submersible power generation system is struck by debris carried within the flowing stream of water.

17. The submersible power generation system of claim 14, wherein said propeller blades are buoyant.

18. The submersible power generation system of claim 15, wherein said hubs are buoyant.

19. The submersible power generation system of claim 16, wherein said propeller blades and hubs are hollow.

20. The submersible power generation system of claim 14, further comprising a control unit for controlling said arms to deploy said generator system.

21. The submersible power generation system of claim 13, further comprising an anchor assembly for anchoring said system within a body of water.

22. The submersible power generation system of claim 13, further comprising a rotatable collar for deploying said system rotatably to a pole embedded in a body of water.
